(19) United States
(12) Patent Application Publication
(10) Pub. No.: US 2022/0039449 A1
(43) Pub. Date: Feb. 10, 2022

(54) GENDER SPECIFIC SYNTHETIC NUTRITIONAL COMPOSITIONS AND NUTRITIONAL SYSTEMS COMPRISING THEM

(71) Applicant: SOCIETE DES PRODUITS NESTLE S.A., Vevey (CH)

(72) Inventors: Carlos Antonio De Castro, Singapore (SG); Francesca Giuffrida, Mezieres (CH); Frederi Destaillats, Servion (CH); Sagar Thakkar, Tresalveo (SG)

(21) Appl. No.: 17/278,896

(22) PCT Filed: Sep. 24, 2019
(86) PCT No.: PCT/EP2019/075622

§ 371 Date: Mar. 23, 2021

(30) Foreign Application Priority Data
Sep. 25, 2018 (EP) 18196455.2

(51) Int. Cl. A23L 33/00; A23L 5/44

(52) U.S. Cl. CPC A23L 33/40; A23L 33/105; A23L 5/44

(57) ABSTRACT

Gender specific synthetic nutritional compositions comprising lutein in concentrations reflecting those found in human milk produced by mothers of infants of the corresponding gender at the corresponding age/stage of lactation, and nutritional systems comprising them.

### TECHNICAL FIELD

The invention relates to gender specific synthetic nutritional compositions, to nutritional systems comprising them, and to their use to provide an optimised amount of lutein and/or one or more health benefit to an infant.

### BACKGROUND OF THE INVENTION

Even though breastfeeding is optimal for infants, the existence of certain conditions may mean that it is contraindicated. In such cases, where the sole source of nutrition is not available to infants, alternative strategies to feed them have to be devised. Feeding infants with synthetic nutritional compositions e.g. Infant formula is one such strategy.

The compositions of the aforementioned synthetic nutritional compositions e.g. infant formulas, aim to replicate those of human milk (hereinafter HM). However, replicating HM is not a simple task. HM not only contains numerous components, its composition is extremely dynamic and these dynamic changes remain largely unexplored and uncharacterized.

The inventors have now surprisingly found that the concentration of Lutein in HM may differ depending on the stage of lactation and the gender of a mother's infant. Because such age and gender differences in the lutein concentration of HM have never been identified previously, these differences are not reflected in the compositions of synthetic nutritional compositions available for infants today. Given that HM is considered the gold standard with respect to infant nutrition, there remains a need for synthetic nutritional compositions tailored for infants of specific ages and genders which better reflect these identified differences.

### SUMMARY OF THE INVENTION

The invention is set out in the claims. The inventors have developed gender specific synthetic nutritional compositions for infants comprising lutein in concentrations that mimic the concentration of lutein found in HM produced for infants of the same age (corresponding lactation stage) and gender.

The gender specific synthetic nutritional compositions may for example, be an infant formula or a composition for an infant that is intended to be added to, or diluted with human milk.

The gender specific synthetic nutritional compositions of the invention can be prepared from a gender neutral synthetic nutritional composition by measuring out an appropriate amount of said gender neutral synthetic nutritional composition and mixing it with an additive and/or diluent e.g. lutein and/or water.

The gender specific synthetic nutritional compositions of the invention may be included in a nutritional system. Said nutritional system may comprise a gender specific synthetic nutritional composition for a female infant and/or a gender specific composition for a male infant of the same age. A gender specific synthetic nutritional composition for a male infant may comprise more lutein than a gender specific synthetic nutritional composition for a female infant of the same age. Said gender specific synthetic nutritional compositions may be for infants of an age selected from the group consisting of: up to 4 months of age and, 4 months of age or older.

The lutein concentration of a gender specific synthetic nutritional composition of the invention reflects the lutein concentration found in HM produced for an infant of the same gender and age (at a corresponding lactation stage). Because HM is considered optimal with respect to infant nutrition, a gender specific synthetic nutritional composition of the invention, and therefore a nutritional system comprising same, may provide an optimized amount of lutein to an infant, for example an infant having the same gender and age as the gender and age to whom the synthetic nutritional composition is directed. The gender specific synthetic nutritional compositions may be used to ensure optimum lutein intake and levels, and thereby to optimize antioxidant capacity as well as skin health and retinal development.

### DETAILED DESCRIPTION

The inventors performed a longitudinal study evaluating the nutrient composition of HM collected from mothers at various stages of lactation (30 days (1 month), 60 days (2 months), and 120 days (4 months) postpartum). Surprisingly the results of this study indicated that the concentration of lutein found in HM can differ depending on the stage of lactation and/or the gender of a mother's infant. In particular, this study indicated that the concentration of lutein may be higher in HM produced by mothers to boys than in HM produced by mothers to girls at the same lactations stage. Details of the study, analysis techniques and results are given in example 1.

Based on the findings of the study, the inventors have designed gender specific synthetic nutritional compositions that comprise lutein in concentrations that reflect the lutein concentrations found in HM produced for infants of the same gender and age (at the corresponding stage of lactation).

In an aspect of the present invention there is provided a gender specific synthetic nutritional composition tailored for an infant comprising lutein in a concentration reflecting the concentration found in HM produced for an infant of the same gender and age/at the corresponding lactation stage e.g. up to 4 months, up to 2 months, 4 months and later.

In one embodiment, the gender specific synthetic nutritional composition tailored for an infant of a specific gender/age comprises, after reconstitution, a concentration of lutein reflecting that found in human milk produced for an infant of the same gender/age (at the corresponding lactation age).

In an embodiment said gender specific synthetic nutritional composition is tailored for an infant of an age selected from the group consisting of up to 4 months of age, and 4 months of age or older.

The term “gender specific synthetic nutritional composition” as used herein refers to any synthetic nutritional composition, intended to be consumed by an infant that is specifically adapted to the nutritional needs of either a female or male enfant. Non-limiting examples of gender specific synthetic nutritional compositions for infants from birth to 4 months include; infant formulae, and a composition for infants that is intended to be added or diluted with HM e.g. HM fortifier. Non limiting examples of gender specific synthetic nutritional compositions for infants from 4 months to 12 months include infant formulae, a composition for infants that is intended to be added or diluted with HM e.g. HM fortifier, or food stuffs intended for consumption by infants either alone or in combination with HM e.g. complementary foods.

The term “infant” as used herein refers to a human infant of 12 months of age or less.

In one embodiment, the infant according to the present invention is in need of lutein.

In another embodiment, the infant is in need of lutein and has non-optimal/sub-optimal lutein levels' intake.

In an embodiment there is provided a gender specific synthetic nutritional composition wherein the concentration of lutein is tailored to a male infant of up to 4 months of age and it is within a range of 0.02 to 0.17 μg/mL e.g. within a range of 0.03 to 0.12, 0.05 to 0.09, 0.06 to 0.08 μg/mL.

In an embodiment there is provided a gender specific synthetic nutritional composition wherein the concentration of lutein is tailored to a female infant of up to 4 months of age and it is within a range of 0.02 to 0.22 μg/mL e.g. within range of 0.03 to 0.11, 0.05 to 0.09, 0.04 to 0.08 μg/mL.

Non-limiting examples of ages up to 4 months of age include up to 2 months of age, 2 to 3 months of age, 2 months of age and 3 months of age. Non-limiting examples of ages up to 2 months of age include; up to 2 weeks, up to 1 month, 1 month, and 2 weeks up to 1 month of age.

In an embodiment there is provided a gender specific synthetic nutritional composition wherein the concentration of lutein is tailored to a male infant of 4 months of age and older and it is within a range of 0.02 to 0.1 μg/mL e.g. within a range of 0.04 to 0.08, 0.05 to 0.06 μg/mL.

In an embodiment there is provided a gender specific synthetic nutritional composition wherein the concentration of lutein is tailored to a female infant of 4 months of age and older and it is within a range of 0.02 to 0.15 μg/mL e.g. within in a range of 0.025 to 0.062, 0.04 to 0.06 μg/mL. Non limiting examples of an age 4 months of age and older include; 4, 5, 6, 7, 8, 9, 10, 11, and 12 months of age, 4 to 6 months of age, 4 to 12 months of age, 6 to 12 months of age, 6 to 9 months of age, and 9 to 12 months of age.

The lutein concentration of the gender specific synthetic nutritional compositions defined herein is expressed in μg/mL. This may refer to the lutein concentration of a reconstituted e.g. within water, gender specific synthetic nutritional composition.

The term “lutein” as used herein refers to, free lutein, lutein esters, lutein salts and/or any combination of the foregoing. Free lutein refers to β,ε-carotene-3,3′-diol. Lutein esters and lutein salts respectively refer to esters or salts of β,ε-carotene-3,3′-diol. β,ε-carotene-3,3′-diol as referred to herein may be cis or trans or a mixture thereof.

The lutein concentration of a composition can be measured by methods well known in the art. For example, the lutein concentration of HM or a gender specific composition of the invention may be measured by extraction of the lutein with organic solvents e.g. BHT/Hexane/ethyl acetate. The analytical measurement of these extracted molecules may be done in two steps. The first step may be chromatographic separation by HPLC e.g. using isooctane/ethylacetate. This step can be followed by second step of detection by diode array detectors and UV detectors. A method for the measurement of lutein in HM or in a gender specific composition as disclosed herein is set out in the examples included herein.

Any form of lutein suitable for administration to an infant to whom the gender specific synthetic nutritional composition is directed may be comprised within in the gender specific synthetic nutritional compositions of the invention. Lutein may for example be added as free lutein, lutein esters, lutein salts and/or any combination of the foregoing.

The lutein, in any form it is used, may stem from natural sources, in particular it may stem from animal or plant or algal sources of lutein that are either in free or esterified form.

The gender specific synthetic nutritional compositions of the invention can also comprise any other ingredients or excipients known to be employed in the type of gender specific synthetic nutritional composition in question e.g. infant formula, a composition for infants that is intended to be added to or diluted with human milk, HM fortifier, follow on formula, or food stuffs intended for consumption by infants e.g. complementary foods.

In an embodiment of the present invention the gender specific synthetic nutritional composition is selected from the group consisting of: infant formula, and a composition for infants that is intended to be added to or diluted with human milk.

Non-limiting examples of ingredients known to be employed in the type of gender specific synthetic nutritional composition in question include: proteins, amino acids, carbohydrates, oligosaccharides, lipids, prebiotics or probiotics, essential fatty acids, nucleotides, nucleosides, vitamins, minerals and other micronutrients.

Non limiting examples of proteins include: casein, alpha-lactalbumin, whey, soy protein, rice protein, corn protein, oat protein, barley protein, wheat protein, rye protein, pea protein, egg protein, sunflower seed protein, potato protein, fish protein, meat protein, lactoferrin, serum albumin, immunoglobins, and combinations thereof.

Non limiting examples of amino acids include leucine, threonine, tyrosine, Isoleucine, arginine, alanine, histidine, isoleucine, proline, valine, cysteine, glutamine, glutamic acid, glycine, serine, arginine, lysine, methionine, phenylalanine, tryptophane, asparagine, aspartic acid, and combinations thereof.

Non limiting examples of carbohydrates include lactose, saccharose, maltodexirin, starch, and combinations thereof.

Non limiting examples of lipids include: palm olein, high oleic sunflower oil, high oleic safflower oil, canola oil, fish oil, coconut oil, bovine milk fat, and combinations thereof.

Non limiting examples of essential fatty acids include: linoleic acid (LA), α-linolenic acid (ALA) and polyunsaturated fatty acids (PUFAs). The gender specific synthetic nutritional compositions of the invention may further contain gangliosides monosialoganglioside-3 (GM3) and disialogangliosides 3 (GD3), phospholipids such as sphingomyelin, phospholipids phosphatidylcholine, phosphatidylethanolamine, phosphatidylinositol, phosphatidylserine, and combinations thereof.

None limiting examples of prebiotics include: oligosaccharides optionally containing fructose, galactose, mannose; dietary fibers, in particular soluble fibers, soy fibers; inulin; and combinations thereof. Preferred prebiotics are fructo-oligosaccharides (FOS), galacto-oligosaccharides (GOS), isomalto-oligosaccharides (IMO), xylo-oligosaccharides (XOS), arabino-xylo oligosaccharides (AXOS), mannan-oligosaccharides (MOS), oligosaccharides of soy, glycosylsucrose (GS), lactosucrose (LS), lactulose (LA), palatinose-oligosaccharides (PAO), malto-oligosaccharides, gums and/or hydrolysates thereof, pectins and/or hydrolysates thereof, and combinations of the foregoing.

Further examples of oligosaccharide are described in Wrodnigg, T. M.; Stutz, A. E. (1999) Angew. Chem. Int. Ed. 38:827-828 and in WO 2012/069416.

Non limiting examples of probiotics include: Bifidobacterium, Lactobacillus, Lactococcus, Enterococcus, Streptococcus, Kluyveromyces, Saccharoymces, Candida, in particular selected from the group consisting of Bifidobacterium longum, Bifidobacterium lactis, Bifidobacterium animalis, Bifidobacterium breve, Bifidobacterium infantis, Bifidobacterium adolescentis, Lactobacillus acidophilus, Lactobacillus casei, Lactobacillus paracasei, Lactobacillus salivarius, Lactobacillus lactis, Lactobacillus rhamnosus, Lactobacillus johnsonii, Lactobacillus plantarum, Lactobacillus salivarius, Lactococcus lactis, Enterococcus faecium, Saccharomyces cerevisiae, Saccharomyces boulardii or mixtures thereof.

Non limiting examples of Nucleotides include: cytidine monophosphate (CMP), uridine monophosphate (UMP), adenosine monophosphate (AMP), guanosine monophosphate (GMP), and combinations thereof.

Non limiting examples of vitamins and minerals include: vitamin E, vitamin B1, vitamin B2, vitamin B6, vitamin B12, vitamin K, vitamin C, vitamin D, folic acid, inositol, niacin, biotin, pantothenic acid, choline, calcium, phosphorous, iodine, iron, magnesium, copper, zinc, manganese, chloride, potassium, sodium, selenium, chromium, molybdenum, taurine, L-carnitine, and combinations thereof. Minerals are usually added to a gender specific composition of the invention in salt form.

Other suitable and desirable ingredients of synthetic nutritional compositions, that may be employed in the gender specific synthetic nutritional compositions of the invention are described in guidelines issued by the Codex Alimentarius with respect to the type of synthetic nutritional composition in question e.g. Infant formula, HM fortifier, follow on formula, or food stuffs intended for consumption by infants e.g. complementary foods.

The gender specific synthetic nutritional compositions of the invention may be prepared by methods well known in the art for preparing the type of gender specific synthetic nutritional composition in question e.g. infant formulae, follow on formulae, a composition for infants that is intended to be added or diluted with HM e.g. HM fortifier, or food stuffs intended for consumption by infants either alone or in combination with HM e.g. complementary foods.

An exemplary method for preparing a gender specific powdered infant formula is as follows. A protin source, carbohydrate source, and fat source may be blended together in appropriate proportions. Emulsifiers may be included in the blend. Vitamins and minerals (including lutein, for example as part of a vitamin premix) may be added at this point but are usually added later to avoid thermal degradation. Any lipophilic vitamins, emulsifiers and the like may be dissolved into the fat source prior to blending. Water, preferably water which has been subjected to reverse osmosis, may then be mixed in to form a liquid mixture.

The liquid mixture may then be thermally treated to reduce bacterial loads. For example, the liquid mixture may be rapidly heated to a temperature in the range of about 80° C. to about 110° C. for about 5 seconds to about 5 minutes. This may be carried out by steam injection or by heat exchanger; for example a plate heat exchanger.

The liquid mixture may then be cooled to about 60° C. to about 85° C.; for example by flash cooling. The liquid mixture may then be homogenised; for example in two stages at about 7 MPa to about 40 MPa in the first stage and about 2 MPa to about 14 MPa in the second stage. The homogenised mixture may then be further cooled to add any heat sensitive components such as vitamins and minerals (if not added earlier, lutein may be added at this stage, for example as part of a vitamin premix). The pH and solids content of the homogenised mixture is conveniently standardised at this point.

The homogenised mixture can be transferred to a suitable drying apparatus such as a spray drier or freeze drier and converted to powder. The powder should have a moisture content of less than about 3% by weight.

If it is desired probiotic(s) can be added, they may be cultured according to any suitable method and prepared for addition to the infant formula by freeze-drying or spray-drying for example. Alternatively, bacterial preparations can be bought from specialist suppliers such as Christian Hansen and Morinaga already prepared in a suitable form for addition to food products such as infant formula. Such bacterial preparations may be added to the gender specific powdered infant formula by dry mixing.

The gender specific synthetic nutritional compositions of the invention may also be prepared from a gender neutral synthetic nutritional composition. In an aspect of the present invention there is provided a method of preparing a gender specific synthetic nutritional composition comprising: measuring out an appropriate amount of said gender neutral synthetic nutritional composition and mixing it with an additive and/or a diluent e.g. lutein and/or water so as to arrive at a gender specific synthetic nutritional composition in accordance with the invention.

In one embodiment, the additive comprises lutein.

The additive may be a gender specific additive comprising lutein in a particular concentration so that when mixed with the gender neutral synthetic nutritional composition, and optionally a diluent, the resulting mixture is a gender specific synthetic nutritional composition in accordance with the invention.

The gender neutral synthetic nutritional composition can be prepared by methods well known in the art for the type of composition in question e.g. as laid out above for infant formula.

The term “gender neutral” as used herein is synonymous with unisex.

One or more of the gender specific synthetic nutritional compositions of the invention can be included in a nutritional system.

The term “nutritional system” as used herein refers to a collection of more than one synthetic nutritional composition advertised or sold as part of the same product range e.g. a collection of infant formulas sold under the same brand and adapted/tailored to the nutritional needs of infants of differing ages and/or genders and/or delivered by different methods e.g. C-section. In one embodiment, the synthetic nutritional compositions making up the nutritional system are packaged individually e.g. in capsules or boxes. Said packages can be sold individually, grouped together e.g. wrapped by plastic film or combined in a box, or in a combination of these two ways. The nutritional system may also comprise synthetic nutritional compositions for children older than 12 months.

In a further aspect of the present invention there is provided a nutritional system comprising a gender specific synthetic nutritional composition of the invention.

In an embodiment the nutritional system comprising a gender specific synthetic nutritional composition for a male infant as defined herein and, a gender specific nutritional composition for a female infant as defined herein. In a more specific embodiment said male and female gender specific synthetic nutritional compositions are for infants of the same age and the concentration of lutein in said gender specific synthetic nutritional composition for a male infant is higher from that in said gender specific synthetic nutritional composition for a female infant.

The concentration of lutein in said male gender synthetic nutritional compositions may be higher by any amount.

In an embodiment, the nutritional system comprises a gender specific synthetic nutritional composition for a male infant up to 4 months of age, and a gender specific synthetic nutritional composition for a female infant up to 4 months of age wherein, the concentration of lutein in said male gender specific synthetic nutritional composition is higher than the lutein concentration of said female gender specific synthetic nutritional composition

Said male gender specific synthetic nutritional composition may comprise for example 0.03 to 0.85 μg/mL, more lutein than the female gender specific synthetic nutritional composition e.g. 0.05 to 0.25, 0.05 to 0.07 μg/mL more lutein than the female gender specific synthetic nutritional composition.

In yet another specific embodiment the nutritional system comprises a gender specific synthetic nutritional composition for a male infant of 4 months of age or older, and a gender specific synthetic nutritional composition for a female infant of 4 months of age or older wherein, the concentration of lutein in said male gender specific synthetic nutritional composition is higher than the lutein concentration of said female gender specific synthetic nutritional composition.

The concentration of lutein in said male gender synthetic nutritional compositions may be higher by any amount.

Said male gender specific synthetic nutritional composition may comprise for example 0.01 to 0.3 μg/mL more lutein than the male gender specific synthetic nutritional composition e.g. 0.01 to 0.04, 0.02 to 0.03 μg/mL more lutein than the male gender specific synthetic nutritional composition.

The nutritional system of the invention may also comprise nutritional compositions for children older than 12 months.

Gender specific synthetic nutritional compositions according to the invention are particularly suitable for use in a method of preparing single servings of infant formula using capsules, each capsule of which contains a unit dose of a synthetic nutritional composition e.g. a gender specific synthetic nutritional composition in a concentrated form, and which is equipped with opening means contained within the capsule to permit draining of the reconstituted synthetic nutritional composition directly from the capsule into a receiving vessel such as a baby bottle. Such a method is described in WO2006/077259.

The different synthetic nutritional compositions, including synthetic nutritional compositions tailored for an infant of a specific age and/or genders, may be packed into individual capsules and presented to the consumer in multipacks containing a sufficient number of capsules to meet the requirements of an infant of a particular age/age range and/or gender, for one week for example. Suitable capsule constructions are disclosed in WO2003/059778.

The different synthetic nutritional compositions, including gender specific and gender neutral synthetic nutritional compositions, which may be comprised within a nutrition system, may be packed into individual capsules and presented to the consumer in multipacks containing a sufficient number of capsules to meet the requirements of an infant of a particular age or range for one week for example. Suitable capsule constructions are disclosed in WO2003/059778.

The capsules can contain the synthetic nutritional compositions, (gender specific and gender neutral) in the form of powders or concentrated liquids in both cases for reconstitution by an appropriate amount of water. Both the composition and the quantity of infant formula in the capsules may vary according to the gender and/or age of the infant. If necessary, different sizes of capsules may be provided for the preparation of infant formulas for infants of different genders and/or ages.

Because HM is the gold standard when it comes to infant nutrition, and because the lutein concentration of the gender specific synthetic nutritional compositions of the invention better reflect the lutein concentration found in HM at the corresponding lactation stage for mothers of infants of the corresponding gender, they, and the nutritional systems comprising them, may be used to provide an optimum amount of lutein to an infant and to ensure optimum lutein levels, and to prevent conditions associated with non-optimal lutein levels.

Lutein is a lipophilic nutrient that is necessary for retina development. It has also role in cognitive development and skin health. It also has antioxidant capacity.

In another aspect of the present invention there is provided a gender specific synthetic nutritional composition of the invention for use to prevent and/or treat non-optimal/sub-optimal lutein levels, antioxidant capacity, skin health and/or retinal development in an infant, for example in an infant up to 4 months of age, or 4 months of age or older.

In another aspect of the present invention there is provided the use of a gender specific synthetic nutritional composition of the invention and/or a nutritional system of the invention to provide an optimum amount of lutein to an infant, to optimize antioxidant capacity, to optimize skin health and/or, to optimize retinal development, for example, in an infant up to 4 months of age, or 4 months of age or older.

In another aspect of the present invention there is provided the use of a nutritional system of the invention to provide an optimum amount of lutein to an infant, to optimize antioxidant capacity, to optimize skin health and/or, to optimize retinal development, for example, in an infant up to 4 months of age, or from 4 months of age.

The nutritional system may provide an optimum amount of Lutein to an infant up to 12, 11, 10, 9, 8, 7, 6, 5, 4, 3, 2, 1 months of age and/or up to 2 weeks of age.

In another aspect of the present invention there is provided a method for treating and/or preventing sub-optimal lutein levels in an infant or for providing an optimum amount of lutein to an infant comprising:
a) Optionally preparing a gender specific synthetic nutritional composition of the invention from a gender-neutral synthetic nutritional composition;
b) Feeding a gender specific synthetic nutritional composition according to the invention to an infant, for example, an infant of the corresponding gender and age, for example in particular an infant of up to 4 months of age, or 4 months of age or older.

As stated herein. The gender specific synthetic nutritional compositions may be prepared from gender neutral synthetic nutritional compositions. Accordingly, in another aspect of the present invention there is provided a kit for providing an optimized amount of lutein to an infant, for example, an infant up to 4 months of age, or 4 months of age or older, the kit comprising:
a) A gender neutral synthetic nutritional composition
b) A label indicating dosage requirements for an infant so as to arrive at a gender specific nutritional composition in accordance with the invention.

The dosage requirements may be with respect to the quantity of the gender neutral synthetic nutritional employed and/or consumption frequency e.g. 4 times per day.

It should be appreciated that all features of the present invention disclosed herein can be freely combined and that variations and modifications may be made without departing from the scope of the invention as defined in the claims. Furthermore, where known equivalents exist to specific features, such equivalents are incorporated as if specifically referred to in this specification.

There now follows a series of non-limiting examples that serve to illustrate the invention.

### EXAMPLES

### Example 1

### Longitudinal Clinical Trial:

The present inventors designed a longitudinal clinical trial with 50 lactating mothers with milk sampling at 30 (visit 1), 60 (visit 2) and 120 (visit 3) days post-partum. The milk samples were quantitatively analyzed for lutein.

Human milk collection: The protocol and collection of human milk was reviewed and approved by the local ethical committee of Singapore. The study took place at National University of Singapore. Volunteer mothers of term infants, who were apparently healthy and non-smokers (n=50; 31.1±3.1-year old) provided breast milk samples (approximately 30 mL). Samples were collected after full expression from one breast using a milk pump, while the baby was fed on the other breast. All efforts were made to collect complete feed that included fore-milk, mid-milk and hind-milk as a representation of one feed, to avoid within feed variation of lipid content. Approximately 30 mL aliquot was separated in a conical polypropylene tube for this study and the rest was fed to the infant. Samples collected for research were stored at −80′C until analyses. Data collection points were 30 days (1 month), 60 days (2 months) and 120 days (4 months) postpartum.

### Measurement of the Lutein Concentrations in Samples:

The lutein concentration of each sample was measured by extraction of the lipids and lipophilic molecules by organic solvents. The analytical measurement of these extracted molecules was done in two steps. The first step was chromatographic separation by HPLC followed by second step of detection by diode array detectors and UV detectors.

### Material and Methods

### Chemicals

Lutein (>75%) was purchased from Merck/Sigma-Aldrich (Darmstadt, Germany). ULC/MS grade water and absolute methanol produced by Biosolve were purchased from Chemie Brunschwig AG (Basel, Switzerland). HPLC-grade water was prepared using a Millipore Milli-Q purification system (EMD Millipore, Billerica, Mass.). All other HPLC-grade solvents and reagents were purchased from Merck/Sigma-Aldrich (Darmstadt, Germany).

### Preparation of Standard Solutions

All preparations took place in a laboratory where the light source was equipped with UV filters to avoid degradation of light-sensitive carotenoids. To ensure accuracy, positive displacement pipettes (Microman, Gilson®) were used in the preparation of all standard and calibration solutions.

Standard solutions. Stock standard solutions were individually prepared at target concentrations by dissolving lutein in the appropriate solvent (see Table A).

TABLE A

| | | Dilution | | | | |
|---|---|---|---|---|---|---|
| | | solvent | Dilution | | | |
| | Stock | for stock | solvent for | Dilution | Wavelength | |
| Compound | solution | solution | measurement | factor | (nm) | E_{cm}^{1%} |
| Lutein | 1 mg/10 mL | Methylene | Ethanol | 40 | 445 | 2550 |
| | | chloride | | | | |

All the solutions were stored in 2 mL aliquots at −18° C. until use for a maximum of 3 months or 1 year in the case of labelled internal standards. The concentration of each of the standard stock solution was determined by spectrophotometry on a spectrophotometer. For this purpose, an aliquot of each solution was individually pipetted into an amber-glass volumetric flask, evaporated to dryness under a nitrogen stream and dissolved in the appropriate solvent (Table A). UV absorbance of the resulting solutions were measured against reference solvent and extinction coefficients used to back calculate the concentration of stock solutions. Chromatographic purity was also determined. 200 μL of the solutions used for spectrophotometric purity determination were dried down in a HLPC vial and dissolved in 100 μL of isooctane-ethyl acetate (90:10) for injection into the LC system.

Standard stock solutions were combined into a standard intermediate solution pipetting each of the individual stock solutions into a 20-mL amber glass volumetric flask, drying down under a nitrogen stream at room temperature and dissolving in isooctane-ethyl acetate. Final concentrations were 0.5 μg/mL for lutein.

Standard solutions for calibration. Calibrating solutions were prepared by pipetting into individual 2-mL HPLC amber vials a series of different volumes of working standard solutions and a fixed volume (20 μL) of internal standard working solution to provide an extended calibration range. After evaporation to dryness, the residue was dissolved into 100 μL of isooctane-ethyl acetate (90:10) for the analysis of lutein.

### Sample Preparation

Into an 8-mL glass tube, 5 μL of an ethanolic solution of butylated hydroxytoluene (BHT) (79 g/L), 10 of an aqueous solution of deferoxamine mesylate (10 mg/mL), 1 mL ethanol, and 25 μL internal standard working solution were added successively to 750 μL of human milk and mixed. Then, 2.5 mL of n-hexane:ethyl acetate (90:10) (v/v) containing 350 mg/L BHT was added and mixed vigorously in a multitube shaker for 2 minutes in pulse mode and 2 minutes in continuous mode. The tubes were centrifuged at 2500 rpm/min for 10 min at 4° C. and the upper organic phase collected into a clean glass tube. The liquid/liquid extraction process was repeated, the supernatants were combined in the same 8-mL tube and taken down to almost dryness under a nitrogen stream. The residue was quantitatively transferred into a 2-mL microcentrifuge tube using small portions of n-hexane/ethyl acetate 90:10 (v/v), dried and dissolved in 125 μL of isooctane:ethyl acetate 90:10 (v/v). The extracts were centrifuged at 11′000 rpm/min for 10 minutes at room temperature and transferred into low volume HPLC vials for analysis of lutein.

### Chromatographic Analysis

Lutein was analyzed in Normal Phase LC mode using a Hypersil GOLD™ Silica, 1.9 μm, 200×2.1 mm column equipped with a 0.2 μm in-line filter (Thermo, Switzerland). The chromatography system consisted in a Waters Acquity UPLC® system equipped with a photodiode array (PDA) eLambda and a Fluorescence Detector (Waters, Baden, Switzerland). The chromatographic column was kept at 35° C. through analysis. Solvent A was n-hexane for chromatography and solvent B a mix of n-hexane-dioxane 50:50 (V/V) containing 0.01% acetic acid. A gradient of solvent B was applied, starting from 28% at time=0 min ramping to 40% in 2 minutes, to 40% at minute 5 with a constant flow rate of 0.4 mL/min. This was followed by a ramp of 1 minute to 100% solvent B and reduced flow rate of 0.3 ml/min for a 2 minutes cleaning step. The analytical column was slowly requilibrated by increasing both solvent A and flow rate to initial conditions in 2 minutes for a total run time of 10 minutes|. Data were collected and processed using Waters Empower™ software. Calibration and quantification were performed using a linear regression and external standards were analyzed. A gradient of solvent B was applied, starting from 0.5% at time=0 min ramping to 2% in 2 minutes, to 10% at minute 5, 45% at minute 10 and 50% at 12 minutes with a constant flow rate of 0.4 mL/min. This timeframe was followed by a ramp of 1 minute to 100% solvent B and reduced flow rate of 0.3 ml/min for a 2 minutes cleaning step. The analytical column was slowly requilibrated by increasing both solvent A and flow rate to initial conditions in 2 minutes and stabilized 5 minutes for a total run time of 22 minutes. Injection volume was 5 μL. PDA detector recorded signals at 450 nm for lutein. Data were collected and processed using Waters Empower™ software. Calibration and quantification were performed using linear regression with apocarotenal.

The results of the analysis of the HM, with respect to the lutein concentration, are shown in tables 1a and 1 b.

TABLE 1a

| | | Lutein Concentration μg/mL | | | | | |
|---|---|---|---|---|---|---|---|
| | | Female | | | | | |
| Stage | Min | Median | mean | Max | SD | QT1 | QT3 |
| 30 days | 0.027734 | 0.058146 | 0.08144 | 0.224827 | 0.058516 | 0.035668 | 0.109345 |
| 60 days | 0.028459 | 0.04569 | 0.064635 | 0.163888 | 0.045541 | 0.034979 | 0.076501 |
| 120 days | 0.024142 | 0.040044 | 0.057076 | 0.142933 | 0.043038 | 0.029186 | 0.061761 |

TABLE 1b

| | | Lutein Concentration μg/mL | | | | | |
|---|---|---|---|---|---|---|---|
| | | Male | | | | | |
| Stage | Min | Median | Mean | Max | SD | QT1 | QT3 |
| 30 days | 0.024757 | 0.067517 | 0.057437 | 0.095296 | 0.026048 | 0.03143 | 0.069753 |
| 60 days | 0.023241 | 0.075423 | 0.08896 | 0.167049 | 0.052915 | 0.058542 | 0.117463 |
| 120 days | 0.023076 | 0.050009 | 0.058054 | 0.100686 | 0.022862 | 0.044398 | 0.07186 |

Statistical analysis: the results of the compositional analysis were then subject to a statistical analysis employing the following statistical model:

Lutein=B₀+B₁age+B₂age²+B₃sex+B₄age*sex+B₅age²*sex+ε

Age is represented in both linear and quadratic terms and is measured in days. ε refers to the random effect of the model which controls for within subject variability.

The different suffixes (B₀, B₁, B₂ . . . ) represent the different estimated slopes attached to the corresponding variable (age, linear and quadratic, sex and/or their interaction).

Table II shows the estimates for timeframe differences along with the corresponding Pvalues.

The results of the Statistical analysis (statistical inference) are show in in table II.

TABLE II

| Timeframe | Variable | Estimate | SE | Pvalue | Unit |
|---|---|---|---|---|---|
| 30 days | lutein | −0.01848 | 0.01739 | 0.28774 | μg/mL |
| 60 days | lutein | 0.02478 | 0.01760 | 0.15923 | μg/mL |
| 90 days | lutein | 0.03514 | 0.03514 | 0.01894 | μg/mL |
| 120 days | lutein | 0.01260 | 0.01260 | 0.01712 | μg/mL |

### Example 2

Examples of gender specific synthetic nutritional compositions (infant formulas) tailored to infants of up to 4 months of age are given in table III. In combination these are an example of a nutritional system of the invention.

TABLE III

| | Up to 4 months of | | 4 months of age and | |
|---|---|---|---|---|
| | age | | older | |
| | M | F | M | F |
| Ingredients | Per Liter | | Per Liter | |
| Energy (kcal) | 670 | 670 | 630 | 630 |
| Protein (g) | 12.1 | 12.1 | 11.3 | 11.3 |
| Fat (g) | 35.649 | 35.649 | 31.446 | 31.458 |
| Linoleic acid (g) | 5.3 | 5.3 | 4.7 | 4.7 |
| α-Linolenic acid | 675 | 675 | 600 | 600 |
| (mg) | | | | |
| Lactose (g) | 74.7 | 74.7 | 75 | 75 |
| Prebiotic (100% | 4.3 | 4.3 | 4.0 | 4.0 |
| GOS) (g) | | | | |
| Lutein (μg) | 75 | 45 | 50 | 40 |
| Minerals (g) | 2.5 | 2.5 | 2.3 | 2.3 |
| Na (mg) | 150 | 150 | 158 | 158 |
| K (mg) | 590 | 590 | 504 | 504 |
| Cl (mg) | 430 | 430 | 410 | 410 |
| Ca (mg) | 410 | 410 | 378 | 378 |
| P (mg) | 210 | 210 | 208 | 208 |
| Mg (mg) | 50 | 50 | 44 | 44 |
| Mn (μg) | 50 | 50 | 32 | 32 |
| Se (μg) | 13 | 13 | 19 | 19 |
| Vitamin A (μg RE) | 820 | 770 | 800 | 720 |
| Vitamin D (μg) | 10 | 10 | 9.5 | 9.5 |
| Vitamin E (mg TE) | 5.4 | 5.4 | 5.0 | 5.0 |
| Vitamin K1 (μg) | 54 | 54 | 50 | 50 |
| Vitamin C (mg) | 67 | 67 | 95 | 95 |
| Vitamin B1 (mg) | 0.47 | 0.47 | 0.6 | 0.6 |
| Vitamin B2 (mg) | 1 | 1 | 0.6 | 0.6 |
| Niacin (mg) | 6.7 | 6.7 | 3.2 | 3.2 |
| Vitamin B6 (mg) | 0.5 | 0.5 | 0.4 | 0.4 |
| Lactoferrin | 1 | 1 | 0.3 | 0.3 |
| (bovine) g | | | | |
| Folic acid (μg) | 60 | 60 | 95 | 95 |
| Pantothenic acid | 3 | 3 | 5.0 | 5.0 |
| (mg) | | | | |
| Vitamin B12 (μg) | 2 | 2 | 1.3 | 1.3 |
| Biotin (μg) | 15 | 15 | 12.6 | 12.6 |
| Choline (mg) | 67 | 67 | 95 | 95 |
| Fe (mg) | 8 | 8 | 6.3 | 6.3 |
| I (μg) | 100 | 100 | 95 | 95 |
| Cu (mg) | 0.4 | 0.4 | 0.4 | 0.4 |
| Zn (mg) | 5 | 5 | 5.7 | 5.7 |

1. A Gender specific synthetic nutritional composition tailored for an infant comprising lutein in a concentration reflecting the concentration found in human milk produced for an infant of the same gender and age.

2. A gender specific synthetic nutritional composition according to claim 1 wherein, the composition is tailored for an infant of an age selected from the group consisting of up to 4 months of age, and 4 months of age or older.

3. A gender specific synthetic nutritional composition according to claim 2 wherein, when the concentration of lutein is tailored to a male infant of up to 4 months of age it is within the range of 0.02 to 0.17 mg/mL and, when the concentration of lutein is tailored to a female infant of up to 4 months of age it is within the range of 0.02 to 0.22 mg/mL; when the concentration of lutein is tailored to a male infant of 4 months of age or older it is within the range of 0.02 to 0.1 mg/mL and, when the concentration of lutein is tailored to a female infant of 4 months of age or older it is within the range of 0.02 to 0.15 mg/mL.

4. A gender specific synthetic nutritional composition according to claim 1 wherein, the gender specific synthetic nutritional composition is selected from the group consisting of: infant formula, and a composition for infants that is intended to be added to or diluted with human milk.

5-12. (canceled)

13. A method for providing an optimum amount of lutein to an infant comprising:
feeding a gender specific synthetic nutritional composition tailored for an infant comprising lutein in a concentration reflecting the concentration found in human milk produced for an infant of the same gender and age.

14. (canceled)

15. A kit for providing an optimized amount of lutein to an infant, the kit comprising:
a. A gender neutral synthetic nutritional composition
b. A label indicating dosage requirements for an infant so as to arrive at a gender specific synthetic nutritional composition tailored for an infant comprising lutein in a concentration reflecting the concentration found in human milk produced for an infant of the same gender and age.

16. (canceled)

17. A method for providing an optimum amount of Lutein to an infant according to claim 13 wherein the infant is an infant in need thereof.
